(19) United States
(12) Patent Application Publication
(10) Pub. No.: US 2014/0274231 A1
(43) Pub. Date: Sep. 18, 2014

(54) MULTIBAND ANTENNA USING DEVICE METAL FEATURES AS PART OF THE RADIATOR

(71) Applicants: Javier Rodriguez De Luis, Kirkland, WA (US); Alireza Mahanfar, Bellevue, WA (US); Benjamin Shewan, Redmond, WA (US); Stanley Ng, Bellevue, WA (US)

(72) Inventors: Javier Rodriguez De Luis, Kirkland, WA (US); Alireza Mahanfar, Bellevue, WA (US); Benjamin Shewan, Redmond, WA (US); Stanley Ng, Bellevue, WA (US)

(21) Appl. No.: 13/839,879

(22) Filed: Mar. 15, 2013

(51) Int. Cl. H04W 88/06; H04M 1/02

(52) U.S. Cl. CPC H04W 88/06; H04M 1/026
USPC 455/575.7

(57) ABSTRACT

Mobile communication devices include multi-band antennas that use an internal conductor and a perimeter conductor to define antenna sections that are coupled together based on an RF wavelength of interest. The antenna sections can be selected or deselected by shunting to ground using a passive filter device or an active RF switch. In other examples, filters or switches are configured to couple an internal conductor and a portion of a perimeter conductor together to provide an effective antenna length associated with a selected frequency.

### FIELD

The disclosure pertains to mobile communication devices and multiband antennas for such devices.

### BACKGROUND

Antenna design for mobile communication devices has become increasingly challenging due to the increasing number of advanced communication standards that must coexist with legacy standards, all while maintaining small device form factors.

Covering more frequency bands increases the demand on antenna volume, even if all these bands are not to be used simultaneously. Significant mobile device volume must be allocated for the antenna, instead of a mobile device battery or other circuitry for increasing performance, and increases mobile device size.

### SUMMARY

The Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

Multi-band antennas for mobile communication devices such as mobile phones can use a conductive hoop that extends along a device perimeter. In some examples, such antennas also include an internal conductor. One or more filters or switches coupled in series or as ground shunts permit RF signals to be directed to suitable antenna sections based on an RF frequency of interest. Mobile devices can include such antennas, and in some cases, RF filters are used to direct RF signals to the appropriate combination of internal conductor and conductive hoop.

The foregoing and features, and advantages of the disclosed technology will become more apparent from the following detailed description, which proceeds with reference to the accompanying figures.

### BRIEF DESCRIPTION OF THE DRAWINGS

FIGS. 1A-1B illustrate a representative multi-band antenna for a mobile communication device that uses an internal conductor and an exterior conductive hoop having a shunt configured to establish different effective antenna lengths for different frequency bands. FIG. 1A is a back side view of the mobile communication device with a cover removed. FIG. 1B is an exterior frontal view with a display in place and FIG. 1C is an interior frontal view.

FIG. 2 illustrates a representative multi-band antenna for a mobile communication device that uses an internal conductor and an exterior conductive hoop and having a series filters or switches configured to establish different effective antenna lengths for different frequency bands.

FIG. 3 illustrates a representative multi-band antenna for a mobile communication device that uses a segmented exterior conductive hoop and a plurality of series switches or filters configured to establish different effective antenna lengths for different frequency bands.

FIG. 4 illustrates a representative multi-band antenna for a mobile communication device that uses an internal conductor and a segmented exterior conductive hoop and having shunts configured to establish different effective antenna lengths for different frequency bands.

FIG. 5 is a schematic diagram illustrating a multiband mobile communication device antenna that includes a plurality of antenna segments and shunts.

FIG. 6 is a schematic diagram illustrating a multiband mobile communication device antenna that includes a plurality of antenna segments and series switches or filters.

FIG. 7 is a schematic diagram illustrating a multiband mobile communication device antenna that includes a plurality of antenna segments and shunts, and configured for simultaneous communication in two different frequency bands.

FIG. 8 is a schematic diagram illustrating a multiband mobile communication device antenna that includes a two antenna segments and associated series and shunt stacked FET RF switches.

FIG. 9 illustrates a dual band antenna for a mobile communication device.

FIG. 10 is a block diagram of a representative method of communication with a switched multi-band antenna.

FIG. 11 is a system diagram depicting an exemplary mobile communication device.

FIGS. 12A-12C are graphs of total radiation efficiency, radiation efficiency, and reflection coefficient as functions of frequency for an antenna such as shown in FIGS. 1A-1B.

### DETAILED DESCRIPTION

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

In some examples, values, procedures, or apparatus are referred to as “lowest,” “best,” “minimum,” or the like. It will be appreciated that such descriptions are intended to indicate that a selection among many used functional alternatives can be made, and such selections need not be better, smaller, or otherwise preferable to other selections.

As used herein, a perimeter of a mobile communication device is an edge corresponding to an intersection of a side of the device containing the display and a side opposite the display. For typical mobile communication devices, a perimeter is approximately rectangular with a width of between 40 and 60 mm and a height of between about 60 and 80 mm. Typical mobile devices use RF frequencies at a variety of bands between about 700 MHz and 2.7 GHz. Representative frequency bands are at about 850 MHz, 960 MHz, 1.8 GHz, 1.9 GHz, and 2.5 GHz.

As used herein RF frequencies are frequencies between about 10 MHz and 10 GHz. Antenna dimensions for such RF frequencies are generally selected to correspond to even integer multiples of ¼ RF wavelengths, wherein wavelength is a function of frequency and dielectric constant or other material properties. Antenna dimensions are also selected based on apparent lengthening or shortening effects associated with fringing fields. In some examples, antenna selectors are provided as RF filters or RF switches. An antenna selector that electrically connects an end of a conductor to a ground contact in a first frequency band but not in a second frequency band is referred to as coupling or shunting the first frequency band to ground and decoupling the second frequency band from ground. In some examples, RF filters are used that require no control signals and exhibit low resistance to RF signals in a first frequency band and high resistance to RF signals in a second frequency band. Such filters can passively couple and decouple RF signals to ground or other connections.

FIGS. 1A-1C illustrate a representative mobile communication device 100 that includes a multi-band antenna. As shown in FIGS. 1A-1C, the device 100 includes a battery 104, an RF signal cable 108, and a connector assembly 112. An RF feed line 116 extends from the connector assembly 112 to a feed point 117 on a conductive trace 121 of an antenna assembly 120 that extends to and is in electrical contact with a conductive hoop 124. The antenna assembly 120 generally includes a flexible dielectric substrate that supports the conductive trace 121. A conductive tab 128 electrically couples or decouples the conductive trace 121 and a ground contact 136 that is associated with the battery 104 with an antenna selector 132. The conductive hoop 124 extends about a mobile device perimeter and includes a hoop break 126 that defines hoop ends 126A, 126B. The conductive hoop 124 includes a hoop section 125 that extends from the hoop break 126 to a ground connection 142. The antenna assembly 120 is supported by a metal shelf 150 that extends between sides 150A, 150B of the conductive hoop 124 and place either toward a front or back surface of the device 100, and can be electrically isolated from or electrically coupled to the conductive hoop 124. The metal shelf 150 is typically oriented perpendicularly to the sides 150A, 150B and has a flat surface that is parallel to an exterior surface of the device 100.

The antenna selector 132 can be a passive filter network such as a suitable arrangement of resistors, capacitors, and inductors, typically, a low loss passive filter network arrangement of capacitors and inductors. Alternatively, the antenna selector 132 can be a filter device such as a surface acoustic wave (SAW) device, a bulk acoustic wave (BAW) device, a film bulk acoustic resonator (FBAR) device, a solidly mounted resonator (SMR) device, or a stacked crystal filter (SCF) device formed with one or more suitable piezoelectric materials. The antenna selector 132 can also be an active device such as an RF switch or resonator tank circuits including RFMEMS, BST tunable capacitors, or other tunable filters.

The mobile communication device 100 also includes a touch screen display 151, one or more switches for user input 152-155, an RF transceiver 160 and associated processing circuitry, and some components are omitted from FIGS. 1A-1C to simplify illustration.

In some examples, the conductive hoop 124 is connected to ground at the ground connection 142 and the RF transceiver 160 receives and delivers RF signals to and from the conductive hoop 124 and the antenna assembly 120. In the example of FIGS. 1A-1C, the antenna selector 132 is a passive filter device selected to couple the conductive trace 121 to the ground connection 136 in a first frequency band and decouple the conductive trace 121 from the ground 130 in an antenna second frequency band. A first effective length is based on a length of the feed line 116, a distance between the contact area 117 on the conductive trace 120 and the tab 128 and is associated with the first frequency band. The first effective antenna length is generally selected to be an even integer multiple of ¼ of a wavelength associated with the first frequency band. Actual lengths are generally selected in consideration of wavelengths based on dielectric constants of nearby materials and apparent length changes due to fringing fields or other effects.

A second effective length is based on a distance from the contact area 117 at a first end 120A of the antenna assembly 120 to an interconnection between the conductive trace 121 to a second end 120B of the antenna assembly 120 and continuing to the ground connection 142 along the conductive trace 121 and a hoop section 125. The second effective antenna length is generally selected to be an integer multiple of ¼ or ½ of a wavelength associated with the second frequency band. Such lengths are generally selected based on dielectric constants of nearby materials and apparent length changes due to fringing fields or other effects.

Thus, as shown in FIGS. 1A-1C, radiation in a first frequency band and radiation in a second frequency band are coupled to antennas having a first effective length and a second effective length, respectively. The first antenna comprises a portion of the conductive trace 121, and the second antenna comprises a portion of the conductive trace 121 and the hoop section 125.

As shown in FIG. 1C, a frame 152 and a metal shield 150 extend to and are electrically coupled to the conductive hoop 124. A gap 154 separates the frame 152 and the metal shelf 150. The frame 152, the metal shelf 150, and the conductive hoop 124 are typically coupled to ground.

FIGS. 12A-12C are graphs of total radiation efficiency, radiation efficiency, and reflection coefficient as functions of frequency for an antenna such as shown in FIGS. 1A-1C. Curves were obtained with a perfect RF switch and a commercially available RF switch (RF MICRO DEVICES, INC. RF1602). Target frequency bands are at about 850 MHz and 1.9 GHz.

With reference to FIG. 2, a mobile communication device 200 includes a radio frequency transceiver 202 that is coupled via an RF cable 204, waveguide, or other electrical connection to an RF connector 206 and then to an internal conductor 208 that extends width-wise along an interior of the mobile device 200. The internal conductor 208 is generally provided as a part of an antenna assembly that includes a dielectric substrate. Generally, the RF connector 206 is coupled to the conductor 208 at a contact 207 proximate a first end 212 of the conductor 208. The conductor 208 can be situated to provide mechanical strength, to secure one or more mobile device components, to provide shielding, or to separate components. The conductor 208 can be a metallic strip or a metallic conductor formed on a surface of or within a rigid or flexible substrate such as printed circuit board materials and polyimide films, for example. In a typical mobile device, such a conductor generally has a width-wise extent of between about 25 mm and 100 mm and extends over at least about 60%, 80%, or 90% of a mobile device width. A dimension of the conductor 208 along a length-wise (longer) dimension of the mobile device 200 is typically between 1 mm, 3 mm, 5 mm, 10 mm, 20 mm, or 25 mm. Other dimensions can be used as may be convenient based on a particular mobile device form factor, and dimensions for antennas configured for tablet computers, laptops, and other devices can be different. In typical mobile devices such as telephones, mobile device widths are between 40 mm and 70 mm, 45 mm and 65 mm, 50 mm and 60 mm, or 52 mm and 56 mm. Mobile device lengths are typically between 90 mm and 130 mm, 100 mm and 120 mm, and 105 mm and 115 mm.

A switch 222 is proximate a second end 213 of the conductor 208 or at some other location between the first end 212 and the second end 213 based on an effective wavelength of RF radiation to be radiated or detected. The switch 222 is configured to selectively couple RF radiation at one or more frequencies or in one or more frequency bands to a ground conductor 223 while appearing as an open circuit to radiation at one or more different frequencies or frequency bands. Frequency selection is provided by a frequency selector 224 that is coupled to the switch 222.

A conductive hoop 230 extends about a perimeter of the mobile communication device 200 and can be situated external to a mobile device housing, within the mobile device housing, or have hoop sections situated within and without the mobile device housing. A frame 252 and a metallic shelf 250 are coupled to the conductive hoop 230 and separated by a gap 254. If external to the housing, the conductive hoop 230 can be covered with a transparent or opaque dielectric coating so that user contact with the conductive hoop tends to produce no or acceptable perturbations to antenna characteristics. The conductive hoop 230 extends about substantially the entire mobile communication device perimeter, but in other examples extends only about selected sections of the perimeter. As shown in FIG. 2, the conductive hoop 230 is discontinuous at a hoop break 232. At 218, the conductive hoop 230 is connected to ground. In addition, a conductor 216 electrically connects the second end 213 of the internal conductor 208 to the conductive hoop 230 at or near the hoop break 232.

The mobile device 200 is configured to transmit and receive in at least a first frequency band and a second frequency band. With the switch 222 configured to electrically connect the internal conductor 208 to the ground conductor 223 in the first frequency band, a section of the internal conductor 208 extending from the contact 207 to the switch 222 serves as a first antenna for receiving and radiating in the first frequency band. An effective antenna length is associated with a distance between the contact 207 and the switch 222 and is generally selected to correspond to ¼ or ½ of an effective wavelength in the first frequency band, or integer multiples thereof. The effective wavelength is a wavelength based on dielectric constants and waveguide characteristics, and is not necessarily equal to a free space wavelength. An effective antenna length includes effects associate with fringing fields that tend to produce an electrical length of an antenna structure that is different from a physical length.

With the switch 222 in an open position, a second antenna is defined by a section of the internal conductor 208 extending from the contact 207 to the conductive hoop 230, and a section of the conductive hoop 230 extending from the conductor 216 to the ground connection 218. An effective length of the second antenna is selected to correspond to ¼ or ½ of an effective wavelength in the second frequency band, or integer multiples thereof. The effective wavelength is a wavelength based on dielectric constants and waveguide characteristics, and is not necessarily equal to a free space wavelength as discussed above.

In the configuration of FIG. 2, a first antenna for use in a first frequency band or a second antenna for use in a second frequency band can be selected using the switch 222. The first antenna and the second antenna both include at least portions of the conductor 208, but the second antenna is extended with a section of the hoop and a portion of the conductor 216. The hoop break 232 disconnects other sections of the hoop 230 so that these other sections do not substantially contribute to reception or transmission of radiation by either the first antenna or the second antenna.

FIG. 3 illustrates a representative multi-band antenna for a mobile communication device 300 that uses a segmented exterior conductive hoop 306 and a plurality of series switches or filters configured to establish different effective antenna lengths for different frequency bands. The conductive hoop includes hoop sections 306A, 306B, 306C that are electrically separated by gaps 320, 321, 322. An RF connector 304 is electrically connected to the hoop section 306A so as to couple RF signals to a transceiver (not shown in FIG. 3). Single pole, single throw switches 308, 310 are situated to selectably couple hoop sections 306A, 306B. 306C together. A switch controller 314 is coupled to the switches 308, 310, 312 and selects the hoop sections to be electrically coupled. For example, with all switches in an OFF state, RF signals are coupled to and from the RF connector 304 by the hoop section 306A which has an effective length associated with a first frequency band. With the switch 308 in an ON state and switch 310 in an OFF state, an effective antenna length for a second frequency range is based on the total length of hoop sections 306A, 306B. With switches 308, 310 both in an ON state, the total length of the hoop (hoop sections 306A, 306B, 306C) is associated with an effective antenna length for a third frequency range. Thus, the three antenna sections form three different antennas for three different frequency bands. More hoop sections can be provided, if desired, and lengths of hoop sections and placements of gaps can be selected based on an intended effective antenna length. Internal conductors can be used as well to form antenna sections, but are not shown in FIG. 3.

FIG. 4 illustrates a representative multi-band antenna for a mobile communication device 400 that uses an internal conductor 406 and a segmented exterior conductive hoop 404. An RF transceiver 448 is coupled with a cable 449 to an RF connector 408 that provides an electrical contact to the internal conductor 406. Switchable electrical shunts 416, 417, 418 are situated to electrically connect a conductive tab 412 of the internal conductor 406 or the conductive hoop 404 to ground at ground pads 420, 427, 428, respectively. Thus, different effective antenna lengths for different frequency bands are obtained depending on the state of the switchable shunts. For example, if only the shunt 418 is in an ON state so as to couple the conductive hoop 404 to ground, the combination of the internal conductor 406 and the portion of the conductive hoop 404 from a hoop break 403 to the shunt 418 (counter clock-wise in FIG. 4) is formed as an antenna. For other switch settings, different lengths of the conductive hoop 404 are used, up to substantially the entire hoop length. In another example, if the shunt switch 417 is ON, only the internal conductor 406 and the portion of the conductive hoop 404 from the hoop break 403 to the shunt switch 417 contribute to antenna length. Active shunt switches can be selected with antenna controller 450, or passive filter networks based on FBAR, SAW or other technologies can be used.

In the example of FIG. 4, four different antenna lengths can be selected, and are selected based on four different RF frequency bands. Filters used as shunt switches can be electrically unconnected to associated ground pads at all frequency bands except one, thereby defining an antenna length. For example, if shunt switch 418 electrically connects to ground contact 428 only at a third frequency band while other shunt switches appear electrically unconnected, i.e., present a high impedance, an antenna length for the third frequency band is based on a path from the RF connector 408 through the internal conductor 406 and along the conductive hoop 404 to the ground contact 428.

As shown in FIG. 4, the internal conductor is electrically coupled to the conductive hoop 404 near the hoop break. In other examples, additional hoop breaks are provided and one or more internal conductors can be coupled to a conductive hoop near hoop breaks or at other hoop locations.

FIG. 5 is a schematic diagram illustrating a multiband mobile communication device antenna 501 that includes a plurality of antenna segments 502, 504, 506, 508 arranged in series. The antenna segment 502 is coupled to an RF transceiver 512, and RF switches 503, 505, 507 are configured to provide ground connections as directed by a transceiver band selector 510. The antenna segments 502, 504, 506, 508 are provided by one or more conductors internal to a mobile device and one or more conductor segments associated with a perimeter conductive hoop that can be either internal or external. Combined antenna segment lengths can be selected to provide suitable effective antenna lengths for four different frequency bands. The RF switches 503, 505, 507 can be based on FETs or other switching elements as convenient.

FIG. 6 is a schematic diagram illustrating a multiband mobile communication device antenna 601 that includes antenna segments 602, 604, 606, 608 that are coupled in series with RF switches or filters 603, 605, 607. If RF switches are used, a frequency band selector 610 is coupled to the switches 603, 605, 607 to permit selection of a suitable antenna length for a particular frequency band. The antenna segments 602, 604, 606, 608 are provided by one or more conductors internal to a mobile device and/or one or more conductor segments associated with a perimeter conductive hoop that can be either internal or external to the mobile device. An RF transceiver 612 is connected to the antenna segment 602 and this segment can be an internal conductive strip or a portion of a perimeter hoop. Other antenna segments can also be either internal conductors or portions of the perimeter hoop, and a particular sequence and arrangement can be established as is convenient for a selected mobile device configuration.

FIG. 7 is a schematic diagram illustrating a multiband mobile communication device antenna that includes a plurality of antenna segments and shunts, and configured for simultaneous communication in two different frequency bands. Antenna segments 702, 704, 706, 708 are coupled in series, and antenna segments 702, 708 are connected to one or more RF transceivers at RF connectors 712, 714. Typically, RF signals in different frequency bands are associated with different connectors. RF switches 703, 704, 705 are configured to provide ground connections as controlled by a frequency band selector 710.

FIG. 8 is a schematic diagram illustrating a multiband mobile communication device antenna that includes antenna segments 802, 804 and an associated series of FET switches 806 and shunt FET RF switch 808. The switches 806, 808 can include one, two, or more FETs based on anticipated power levels. Higher power levels can generally be accommodated with more than one FET, if single FET capabilities are inadequate.

FIG. 9 illustrates a portion of a mobile communication device 900 illustrating a dual band antenna based on internal conductor 902 and a hoop section 904. An RF connection 906 to a transceiver (not shown in FIG. 9) is situated at a first end 902A of the internal conductor 902. A second end 902B of the internal conductor 902 is electrically connected to the hoop section 904 and an RF switch 910. The RF switch 910 is switchable so as to appear as an open circuit, or to shunt the second end 902B to ground. The hoop section 904 has a first end 904A that electrically unconnected to other hoop sections, and a second end 904B is grounded. Based on the state of the RF switch 900, an antenna length is associated with a length of the internal conductor 902, or the combined length of the internal conductor 902 and the hoop section 904. In the example of FIG. 9, RF signals are coupled to a transceiver at an RF connection 906 on the internal conductor 902. In other examples, RF signals are coupled to a transceiver at an RF connection on the hoop section 904. In some such examples, the RF connection 906 shown in FIG. 9 becomes a ground connection instead.

FIG. 10 is a block diagram of a representative method 1000 of communication with a switched multi-band antenna. At 1010, a frequency band is selected, and at 1004, a corresponding antenna is selected based upon internal conductors and sections of a perimeter conductor. At 1006, communication is performed on the selected frequency band.

FIG. 11 is a system diagram depicting an exemplary mobile device 1100 including a variety of optional hardware and software components, shown generally at 1102. Any components 1102 in the mobile device can communicate with any other component, although not all connections are shown, for ease of illustration. The mobile device can be any of a variety of computing devices (e.g., cell phone, smartphone, handheld computer, Personal Digital Assistant (PDA), etc.) and can allow wireless two-way communications with one or more mobile communications networks 1104, such as a cellular or satellite network.

The illustrated mobile device 1100 can include a controller or processor 1110 (e.g., signal processor, microprocessor, ASIC, or other control and processing logic circuitry) for performing such tasks as signal coding, data processing, input/output processing, power control, and/or other functions. An operating system 1112 can control the allocation and usage of the components 1102 and support for one or more application programs 1114. The application programs can include common mobile computing applications (e.g. email applications, calendars, contact managers, web browsers, messaging applications), or any other computing application.

The illustrated mobile device 1100 can include memory 1120. Memory 1120 can include non-removable memory 1122 and/or removable memory 1124. The non-removable memory 1122 can include RAM, ROM, flash memory, a hard disk, or other well-known memory storage technologies. The removable memory 1124 can include flash memory or a Subscriber Identity Module (SIM) card, which is well known in GSM communication systems, or other well-known memory storage technologies, such as “smart cards.” The memory 1120 can be used for storing data and/or code for running the operating system 1112 and the applications 1114. Example data can include web pages, text, images, sound files, video data, or other data sets to be sent to and/or received from one or more network servers or other devices via one or more wired or wireless networks. The memory 1120 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 1100 can support one or more input devices 1130, such as a touchscreen 1132, microphone 1134, camera 1136, physical keyboard 1138 and/or trackball 1140 and one or more output devices 1150, such as a speaker 1152 and a display 1154. Other possible output devices (not shown) can include piezoelectric or other haptic output devices. Some devices can serve more than one input/output function. For example, touchscreen 1132 and display 1154 can be combined in a single input/output device. The input devices 1130 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 1112 or applications 1114 can comprise speech-recognition software as part of a voice user interface that allows a user to operate the device 1100 via voice commands. Further, the device 1100 can comprise input devices and software that allows for user interaction via a user's spatial gestures, such as detecting and interpreting gestures to provide input to a gaming application.

A wireless modem 1160 can be coupled to a multiband antenna 1191, and a particular frequency band is selected with a band select switch 1192 as controlled by the processor 1110. Computer executable instructions for such selection can be stored in the memory 1122. In some examples, RF filters are used and the processor 1110 need not select an antenna configuration for a selected frequency band. The wireless modem 1160 can support two-way communications between the processor 1110 and external devices. The modem 1160 is shown generically and can include a cellular modem for communicating with the mobile communication network 1104 and/or other radio-based modems (e.g., Bluetooth 1164 or Wi-Fi 1162). The wireless modem 1160 is typically configured for communication with one or more cellular networks, such as a GSM network for data and voice communications within a single cellular network, between cellular networks, or between the mobile device and a public switched telephone network (PSTN).

The mobile device can further include at least one input/output port 1180, a power supply 1182, a satellite navigation system receiver 1184, such as a Global Positioning System (GPS) receiver 1184, an accelerometer 1186, and/or a physical connector 1190, which can be a USB port, IEEE 1394 (FireWire) port, and/or RS-232 port. The illustrated components 1102 are not required or all-inclusive, as any components can be deleted and other components can be added.

Computer-executable instructions for antenna band selection and other applications can be stored in tangible storage that may be removable or non-removable, and includes RAM, ROM, magnetic disks, magnetic tapes or cassettes, CD-ROMs, DVDs, or any other medium which can be used to store information in a non-transitory way and which can be accessed within a computing environment. The term computer-readable storage media does not include communication connections, such as modulated data signals. Any of the computer-executable instructions for implementing the disclosed techniques as well as any data created and used during implementation of the disclosed embodiments can be stored on one or more computer-readable media (e.g., non-transitory computer-readable media, which excludes propagated signals).

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A mobile communication device, comprising:
a radio frequency transceiver;
an antenna comprising a first antenna section extending within the mobile communication device and a second antenna section extending along a portion of a mobile device perimeter, wherein the first and second antenna sections are electrically couplable in series, the first antenna section having a length based on a first RF frequency band and the first antenna section and the second antenna section having a combined length based on a second RF frequency band;
an antenna selector coupled to at least one of the first antenna section and the second antenna section, and configured to couple only one of the first antenna section and the combined first and second antenna sections to the radio frequency transceiver in a selected one of the first and second RF frequency bands.

2. The mobile communication device of claim 1, wherein the antenna selector is an RF filter situated so as to couple the first antenna section to the second antenna section in the first RF frequency band.

3. The mobile communication device of claim 1, wherein the first antenna section has first and second ends, wherein the first end is connected to the RF transceiver and the second end is connected to the second antenna section, and the antenna selector is connected to the first antenna section.

4. The mobile communication device of claim 1, wherein a length of the first antenna section between the first end and the antenna selector is associated with the first RF frequency.

5. The mobile communication device of claim 1, wherein the antenna selector is connected to the first antenna section proximate the second end of the first antenna section.

6. The mobile communication device of claim 4, further comprising a perimeter hoop extending about the mobile communication device, wherein the second antenna section is a portion of the perimeter hoop.

7. The mobile communication device of claim 6, wherein the second antenna section is defined as a section of the perimeter hoop extending from a connection to the first antenna section to a ground contact.

8. The mobile communication device of claim 7, wherein the antenna selector connects the first antenna section to a ground contact proximate the second end of the first antenna section.

9. The mobile communication device of claim 8, wherein the antenna selector is operable to couple RF signals in at least the first frequency band to the ground contact.

10. The mobile communication device of claim 9, wherein the antenna selector is a filter configured to couple RF signals in the first frequency band to the ground contact and decouple RF signals in the second frequency band from the ground contact.

11. The mobile communication device of claim 8, wherein the antenna selector is an RF switch.

12. A multi-band antenna, comprising:
a conductive strip configured to fit within a mobile device housing and to extend along a housing width;
a conductive perimeter hoop comprising at least one hoop break, wherein the conductive strip and the conductive perimeter hoop are electrically couplable in series; and
an antenna selector situated along the conductive strip and electrically connected to the conductive strip and to a first ground contact, and that is configured to couple RF signals in a first frequency band to the first ground contact, and to decouple RF signals in a second frequency band from the first ground contact.

13. The multi-band antenna of claim 12, wherein an effective length of an antenna section corresponding to a portion of the conductive strip terminating at the antenna selector is based on an integer multiple of ½ wavelength in the first frequency band.

14. The multi-band antenna of claim 13, wherein the conductive strip is coupled to the conductive perimeter hoop proximate a hoop end, and the conductive perimeter hoop is coupled to a second ground contact to define a hoop section, wherein the effective length of the combination of the hoop section and the conductive strip is based on a wavelength in the second frequency band.

15. The multi-band antenna of claim 14, further comprising a dielectric layer situated on at least the hoop section.

16. The multi-band antenna of claim 12, wherein the antenna selector is an acoustic wave filter.

17. The multi-band antenna of claim 12, further comprising an RF contact situated proximate a first end of the conductive strip, wherein a second end of the conductive strip is coupled to the perimeter hoop and the RF contact is configured to be coupled to an RF transceiver.

18. The multi-band antenna of claim 12, further comprising a hoop section defined by a portion of the conductive perimeter hoop situated between an RF contact coupled to the conductive perimeter hoop proximate the hoop break and a contact of the conductive perimeter hoop with the conductive strip, wherein an effective length of the hoop section and an effective length of the combined hoop section and the conductive strip are based on wavelengths in the first frequency band and the second frequency band, respectively.

19. The multi-band antenna of claim 12, wherein the antenna selector is an RF switch.

20. A method, comprising:
radiating RF signals in a first frequency band from an internal conductor in a mobile device;
radiating RF signals in a second frequency band from the internal conductor and at least a portion of a perimeter conductor that is coupled in series with the internal conductor.
